(19) United States
(12) Patent Application Publication
(10) Pub. No.: US 2004/0060608 A1
(43) Pub. Date: Apr. 1, 2004

(54) Flexible fluid line connector assembly with brazed end fittings

(75) Inventor: Michael T. Angus, Derry, PA (US)

Correspondence Address: Christopher B. Fagan, Fay, Sharpe, Fagan, Minnich & McKee, LLP, 7th Floor, 1100 Superior Avenue, Cleveland, OH, 44114-2518, US

(73) Assignee: Dormont Manufacturing Company

(21) Appl. No.: 10/672,532

(22) Filed: Sep. 26, 2003

Related U.S. Application Data
(60) Provisional application No. 60/414,259, filed on Sep. 27, 2002.

(51) Int. Cl. F16L 9/00

(52) U.S. Cl. 138/109; 138/110; 138/121; 138/122

(57) ABSTRACT

A fluid line connector assembly has a length of flexible tubing with a generally cylindrical tubing end. An end fitting is secured to the tubing end with a brazing material between the end fitting and the tubing end.

This application claims priority from U.S. Provisional Patent Application No. 60/414,259 filed on Sep. 27, 2002, which is hereby incorporated herein by reference in its entirety.

### INCORPORATION BY REFERENCE

Electroless nickel plating processes, substrate and coating material characteristics, and other details of electroless nickel plating are discussed at length in Electroless Nickel Plating by Wolfgang Riedel (1^{st} ed., 1991) at pages 1-7, 64-159 and 178-220 the disclosure of which is hereby incorporated herein by reference. Brazing materials, methods, joint design and other details of brazing are discussed in Brazing For The Engineering Technologist by M. Schwartz (1^{st} ed., 1995) at pages 1-332 the disclosure of which is hereby incorporated herein by reference.

### BACKGROUND OF THE INVENTION

The present invention relates to the art of fluid line connector assemblies and, more particularly, to thin-walled, flexible fluid line connector assemblies for use in connecting a fluid supply line and an associated device or appliance.

Thin-walled, flexible fluid line connector assemblies have been provided heretofore and generally include a length of thin-walled, corrugated flexible tubing having opposing end fittings supported on each end thereof. Typically, the corrugated flexible tubing is made from stainless steel, and has either annular or helical corrugations extending along its length. The two opposing ends of the length of flexible tubing are cut generally perpendicular to the length of tubing. As such, if the length of tubing has annular corrugations, then each of the cut ends will be relatively uniformly round, as each cut will go through a portion of a single annular corrugation. However, the diameter of the tubing end is dependent upon the position of the cut relative to the annular corrugation. That is, if the cut extends through the valley of a corrugation then the tubing end will have a smaller relative diameter. If the cut extends through the peak of a corrugation the tubing end will have a larger relative diameter. If, on the other hand, the length of tubing has helical corrugations, then each of the cut ends will have an irregular and non-uniform shape, as the cut will extend through multiple corrugations. In either case, the size and shape of the ends of the flexible tubing can vary widely.

Commonly, each of the opposing end fittings used on connector assemblies includes a threaded portion suitable for engaging a corresponding connection, such as a fluid supply line or an associated device or appliance, for example. Typically, an end fitting is welded to each of the ends of the tubing. A task that is made difficult by the varying dimensions and shape of the cut ends of the tubing. Though the flexible tubing is commonly made from a stainless steel alloy, the end fittings are commonly made from carbon steel. Typically, this is done in an effort to reduce costs. As such, the end fittings are normally plated, such as with chrome plating, for example, to improve corrosion resistance of the carbon steel material.

Additionally, known fluid line connector assemblies can include a sheath, such as a braided sheath, for example, that extends along the exterior of the length of tubing. The sheath is commonly secured adjacent each end of the assembly. In many cases, an end fitting and one end of the sheath will be, together, welded to or at the tubing end in one welding operation.

One disadvantage of connector assemblies of the foregoing nature is that welding the end fittings and sheath to the tubing end is a difficult and time-consuming process. This is, at least in part, due to the variations in diameter and shape of the tubing ends as discussed above with regard to cutting through the annular or helical corrugations. Furthermore, these variations in diameter or irregular surfaces make automating the welding process difficult.

Another disadvantage of known connector assemblies is that the welding process normally destroys at least a portion of the plating on the end fittings. This can reduce the corrosion resistance of the connector assembly.

A further disadvantage of known connector assemblies is that the welding process can result in cosmetic imperfections, this undesirably reduces the overall appearance of the connector assembly.

### BRIEF SUMMARY OF THE INVENTION

In accordance with the present invention, a thin-walled, flexible fluid line connector assembly is provided that avoids or minimizes the problems and difficulties encountered in connection with connector assemblies of the foregoing nature, while promoting an increase in performance and reliability, minimizing the cost of manufacture and assembly, and maintaining a desired simplicity of structure.

More particularly in this respect, a fluid line connector assembly is provided for use in connecting a fluid supply line and an associated device or appliance. The fluid line connector assembly includes a length of flexible tubing, such as thin-walled, corrugated, stainless steel tubing, for example, having at least one generally cylindrical, non-corrugated end portion. The fluid line connector assembly also includes an end fitting supported on the end portion of the flexible tubing. The end fitting is receivingly engaged on the end portion, and secure thereto using brazing material capable of withstanding a relatively high temperature, such as temperatures above 300° F., for example.

Another and/or alternate fluid line connector assembly is provided that includes a length of flexible tubing, such as thin-walled, corrugated, stainless steel tubing, for example, having a generally cylindrical, non-corrugated end portion. The fluid line connector assembly also includes an end fitting supported on the end portion, and a sheath extending along the exterior of the flexible tubing and secured, in any suitable manner, to the end fitting supported on the flexible tubing. The end fitting is receivingly engaged on the associated end portion, and is secured to the same using brazing material capable of withstanding a relatively high temperature, such as temperatures above 300° F., for example.

Still another and/or alternate fluid line connector assembly is provided that includes a length of flexible tubing, such as thin-walled, corrugated, stainless steel tubing, for example, having a generally cylindrical, non-corrugated end portion. The fluid line connector assembly also includes an end fitting supported on the end portion, and a sheath extending along the exterior of the flexible tubing and secured to the flexible tubing in any suitable manner adjacent the end fitting thereon. The end fitting is receivingly engaged on the end portion, and is secured to the same using brazing material capable of withstanding a relatively high temperature, such as temperatures above 300° F., for example.

A method of assembling a fluid line connector assembly is provided, which includes the steps of: providing a length of thin-walled, flexible tubing having at least one non-corrugated and generally cylindrical tubing end; providing an end fitting suitable for receivably engaging the tubing end; assembling the end fitting onto the tubing end; and brazing the end fitting onto the tubing end using a brazing material suitable for withstanding relatively high temperatures, such as temperatures above 300° F., for example.

Another and/or alternate method of assembling a fluid line connector assembly is provided, which includes the steps of: providing a length of thin-walled, flexible tubing having a non-corrugated and generally cylindrical tubing end; providing an end fitting suitable for receivably engaging the tubing end; providing a sheath suitable for extending along the exterior of at least a portion of the flexible tubing; assembling the end fitting onto the tubing end; brazing the end fitting onto the tubing end using a brazing material suitable for withstanding relatively high temperatures, such as temperatures above 300° F., for example; installing the sheath along the exterior of the length of flexible tubing; and securing the sheath to the end fitting on the tubing end in any suitable manner.

A further and/or alternate method of assembling a fluid line connector assembly is provided, which includes the steps of: providing a length of thin-walled, flexible tubing having a non-corrugated and generally cylindrical tubing end; providing an end fitting suitable for receivingly engaging the tubing end; providing a sheath suitable for extending along at least a portion of the exterior of the flexible tubing; installing the sheath along at least a portion of the exterior of the length of tubing and securing the sheath adjacent the tubing end in a suitable manner; assembling the end fitting onto the tubing end; and brazing the end fitting to the tubing end using a brazing material suitable for withstanding relatively high temperatures, such as temperatures above 300° F., for example.

One advantage of the present invention is the provision of a fluid line connector assembly that is economical to manufacture and which is suitable for automated assembly processes.

Another advantage of the present invention is the provision of a fluid line connector assembly that avoids the destruction of plated or otherwise finished surfaces on components thereof and thereby minimizes the loss of corrosion resistance due to welded connections.

A further advantage of the present invention is the provision of a fluid line connector assembly that avoids welding and thereby improves the overall cosmetic appearance of the assembly by avoiding the destruction of coated surfaces.

### BRIEF DESCRIPTION OF THE DRAWINGS

FIG. 1 is a side view, partially in section, of a fluid line connector assembly in accordance with the present invention.

FIG. 2 is a side view of the length of flexible tubing of the fluid line connector assembly in FIG. 1.

FIG. 3 is an end view of one end fitting of the fluid line connector assembly in FIG. 1.

FIG. 3A is a side view, in cross section, of the end fitting in FIG. 3 taken along line 3A-3A thereof.

FIG. 4 is an end view of another end fitting of the fluid line connector assembly in FIG. 1.

FIG. 4A is a side view, in cross section, of the end fitting in FIG. 4 taken along line 4A-4A thereof.

FIG. 5 is an enlarged partial cross-sectional view of the fluid line connector assembly in FIG. 1.

FIG. 6 is an enlarged partial cross-sectional view of the fluid line connector assembly in FIG. 1.

FIG. 7 is a side view of another embodiment of a fluid line connector assembly in accordance with the present invention.

FIG. 8 is a side view of the length of flexible tubing of the fluid line connector assembly in FIG. 7.

FIG. 9 is an end view of the end fitting of the fluid line connector assembly in FIG. 7.

FIG. 9A is a side view, in cross section, of the end fitting in FIG. 9 taken along line 9A-9A thereof.

FIG. 10 is an end view of the retaining collar of the fluid line connector assembly in FIG. 7.

FIG. 10A is a side view, in cross section, of the retaining collar inn FIG. 10 taken along line 10A-10A thereof.

FIG. 11 is an end view of another embodiment of an end fitting for use on the fluid line connector assembly of FIG. 7.

FIG. 11A is a side view, in cross section, of the end fitting in FIG. 11 taken along line 11A-11A thereof.

FIG. 12 is an enlarged partial cross-sectional view of the fluid line connector assembly in FIG. 7.

FIG. 13 is an enlarged partial cross-sectional view of the fluid line connector assembly in FIG. 7.

FIG. 14 is a side view of still another embodiment of a fluid line connector assembly in accordance with the present invention.

FIG. 15 is a side view of the length of flexible tubing of the fluid line connector assembly in FIG. 14.

FIG. 16 is an end view of one end fitting of the fluid line connector assembly in FIG. 14.

FIG. 16A is a side view, in cross section, of the end fitting in FIG. 16 taken along line 16A-16A thereof.

FIG. 17 is an end view of the base collar of the fluid line connector assembly in FIG. 14.

FIG. 17A is a side view, in cross section, of the base collar in FIG. 17 taken along line 17A-17A thereof.

FIG. 18 is an end view of the retaining collar of the fluid line connector assembly in FIG. 14.

FIG. 18A is a side view, in cross section, of the retaining collar in FIG. 18 taken along line 18A-18A thereof.

FIG. 19 is an end view of another end fitting of the fluid line connector assembly in FIG. 14.

FIG. 19A is a side view, in cross section, of the end fitting in FIG. 19 taken along line 19A-19A thereof.

FIG. 20 is an enlarged partial cross-sectional view of the fluid line connector assembly in FIG. 14.

FIG. 21 is an enlarged partial cross-sectional view of the fluid line connector assembly in FIG. 14.

### DETAILED DESCRIPTION OF THE INVENTION

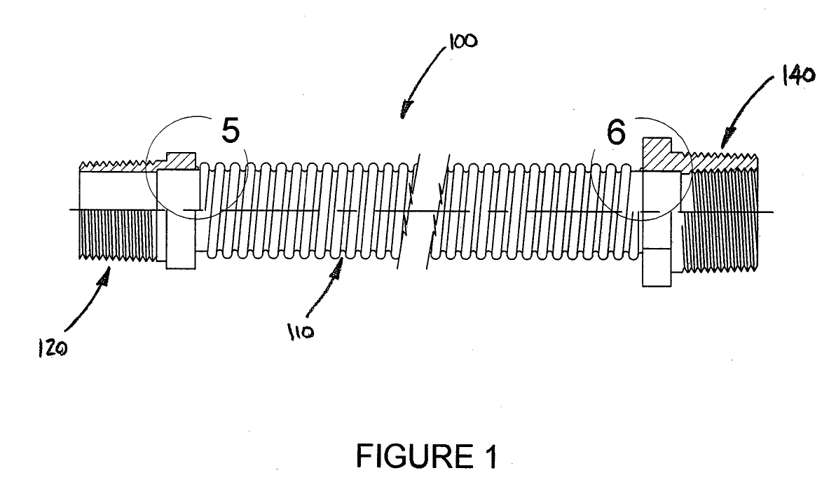

Referring now in greater detail to the drawings, wherein the showings are for the purposes of illustrating preferred embodiments of the invention only, and not for the purpose of limiting the invention, FIG. 1 illustrates a fluid line connector assembly 100 that includes a length of thin-walled, flexible tubing 110, a first end fitting 120, and a second end fitting 140.

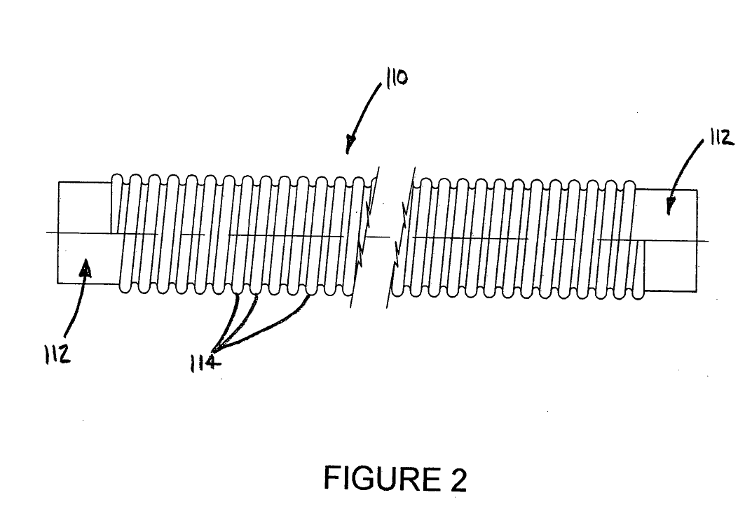

FIG. 24 illustrate various components of connector assembly 100. FIG. 2 shows a length of flexible tubing 110 having cylindrical end portions 112 and a plurality of corrugations 114 extending between the non-corrugated end portions. Typically, tubing 110 is formed from stainless steel. However, it will be appreciated that other suitable materials, such as carbon steel, for example, may be used without departing from the principles of the present invention. The tubing can have a wall thickness of about approximately 0.005 to about approximately 0.035 inches. Commonly, the tubing has a wall thickness of about approximately 0.010 to about approximately 0.015 inches. This falls within the aforementioned broader range, and is not intended as a limitation but merely as an illustration of suitable thickness dimensions. Additionally, corrugations 114 are shown as being helical corrugations. However, it should be appreciated that any other suitable manner of forming flexible tubing may be used, such as using annular corrugations, for example.

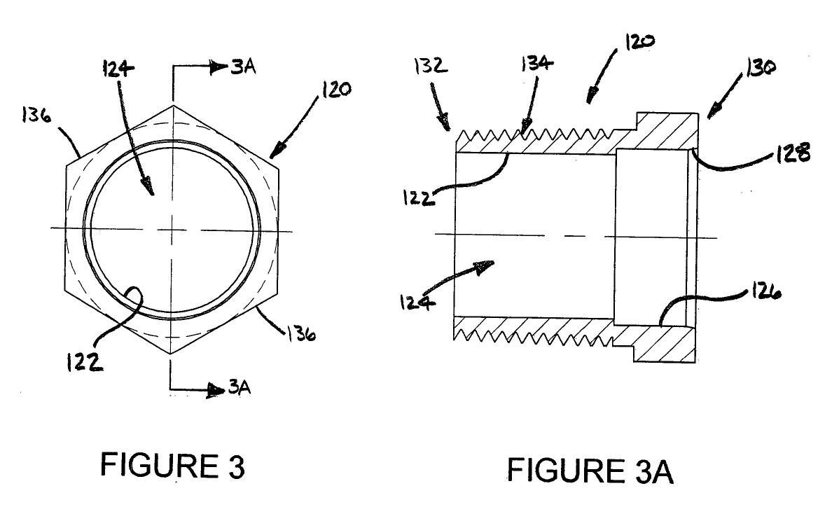

FIGS. 3 and 3A illustrate first end fitting 120, which includes an inside wall 122 defining a passage 124 extending therethrough. The inside wall includes a brazing surface 126, and a chamfer 128 adjacent a tube-engaging end 130. A connecting end 132 extends opposite the tube-engaging end. A plurality of threads 134 are disposed along the exterior of fitting 120 toward the connecting end, and wrench flats 136 are provided adjacent the threads.

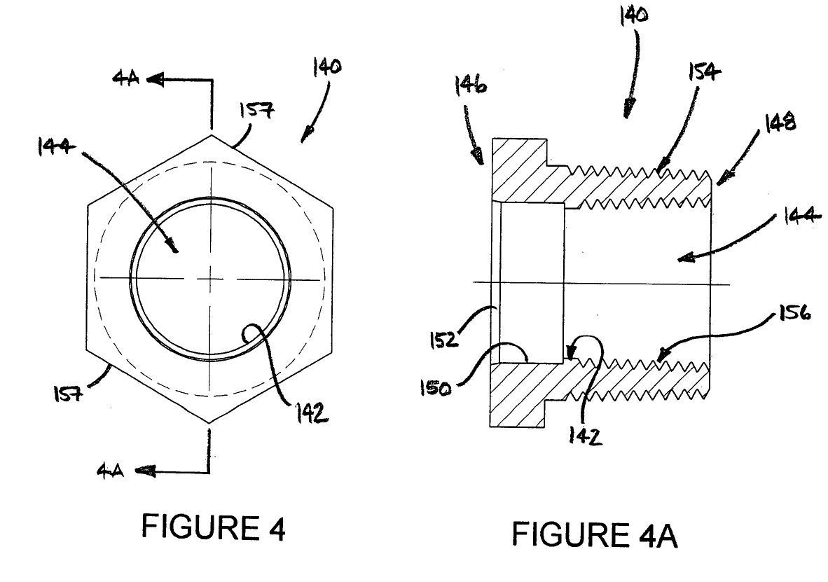

FIGS. 4 and 4A show second end fitting 140 having an inside wall 142 defining a passage 144. The second end fitting has a tube-engaging end 146 and a connecting end 148. Adjacent the tube-engaging end, a brazing surface 150 is disposed along inside wall 142, and a chamfer 152 is provided at the edge thereof. Adjacent connector end 148 is a plurality of male threads 154 extending along the exterior of the end fitting. A plurality of female threads 156 extends along inside wall 142 from connecting end 148. Wrench flats 157 are also provided along the exterior of the end fitting.

End fittings 120, 140 illustrated in at least FIGS. 1, 3, 3A, 4 and 4A are shown as having tapered pipe threads thereon. It will be appreciated, however, that any suitable threads, such as straight threads, for example, or other connection features, such as a flange, for example, can be used without departing from the principles of the present invention. Indeed, the present invention is intended to include the use of end fittings of any geometry or configuration that is suitable for any desired application of a connector assembly in accordance with the present invention. The subject invention is not intended to be limited to the geometry shown in the aforementioned drawing figures, as a nearly unlimited number of end fitting configurations exist that would be suitable for use with the invention in the present application.

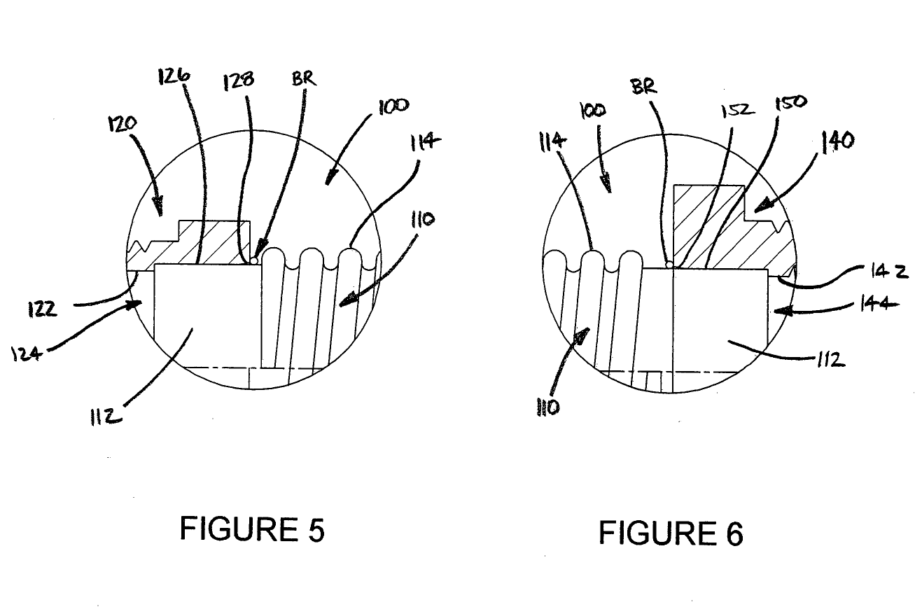

End fittings 120 and 140 are each retained on a different one of end portions 112 of flexible tubing 110 by a brazed joint or connection. And, it is to be specifically understood that such a brazed connection does not include welding, welded joints, or other welded connections or arrangements. FIGS. 5 and 6 respectively illustrate fittings 120 and 140 supported on the end portions of the flexible tubing. A braze ring BR is positioned adjacent chamfers 128 and 152, as respectively shown in FIGS. 5 and 6.

One method of assembling a connector assembly in accordance with the present invention, such as connector assembly 100, includes the steps of: providing a length of flexible tubing 110, such as thin-walled, corrugated tubing, for example, having at least one non-corrugated and generally cylindrical end portion 112; providing an end fitting 120, 140 suitably adapted to receivingly engage one or more of the at least one end portion; assembling each of the provided end fittings onto an associated one of the at least one end portion of the flexible tubing; and brazing each end fitting onto the associated end portion using a brazing material suitable for withstanding relatively high temperatures, such as temperatures above 300° F., for example.

The brazing material can take any one of various forms, such as a rod, a length of wire, or braze ring BR, for example. It will be appreciated that braze ring BR can be a continuous ring, or a discontinuous or split ring. As a continuous ring, it is desirable to assemble braze ring BR onto the end portion prior to receiving the end fitting. However, in other forms the brazing material may be introduced at any one of various points during the assembly process, such as prior to assembly of the end fitting onto the end portion or during the braze operation itself, for example.

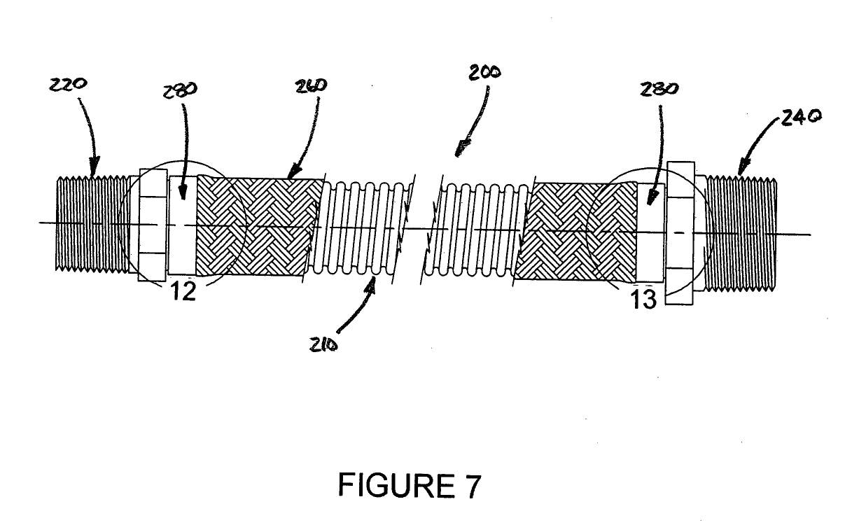

FIG. 7 illustrates another and/or alternate embodiment of a fluid line connector assembly 200 that includes a length of thin-walled, flexible tubing 210, a first end fitting 220, a second end fitting 240, a sheath 260, and a retaining collar 280 adjacent each of the end fittings.

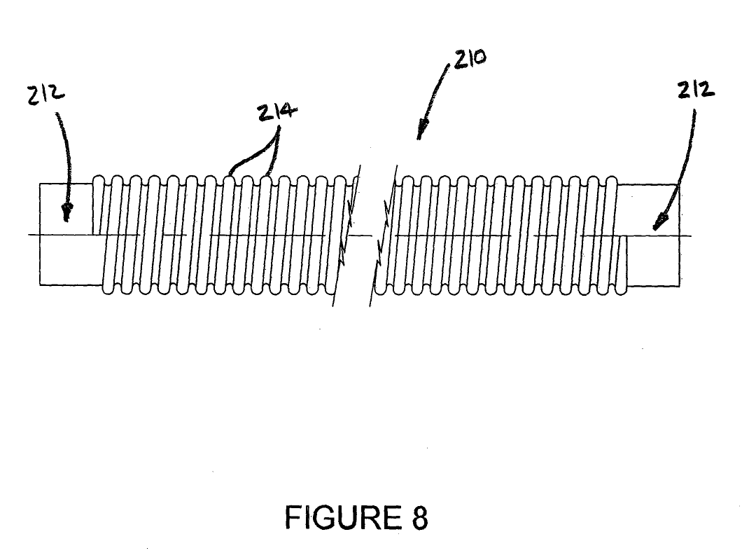

FIGS. 8-11 illustrate various components of connector assembly 200. FIG. 8 shows a length of flexible tubing 210 having cylindrical end portions 212 and a plurality of corrugations 214 extending between the non-corrugated end portions. Typically, tubing 210 is formed from stainless steel. However, it will be appreciated that other suitable materials, such as carbon steel, for example, may be used without departing from the principles of the present invention. The tubing can have a wall thickness of about 0.005 to about 0.035 inches. Commonly, the tubing has a wall thickness of about 0.010 to about 0.015 inches. This falls within the aforementioned broader range, and is not intended as a limitation but merely as an illustration of suitable thickness dimensions. Additionally, corrugations 214 are shown as being helical corrugations. However, it should be appreciated that any other suitable manner of forming flexible tubing may be used, such as using annular corrugations, for example.

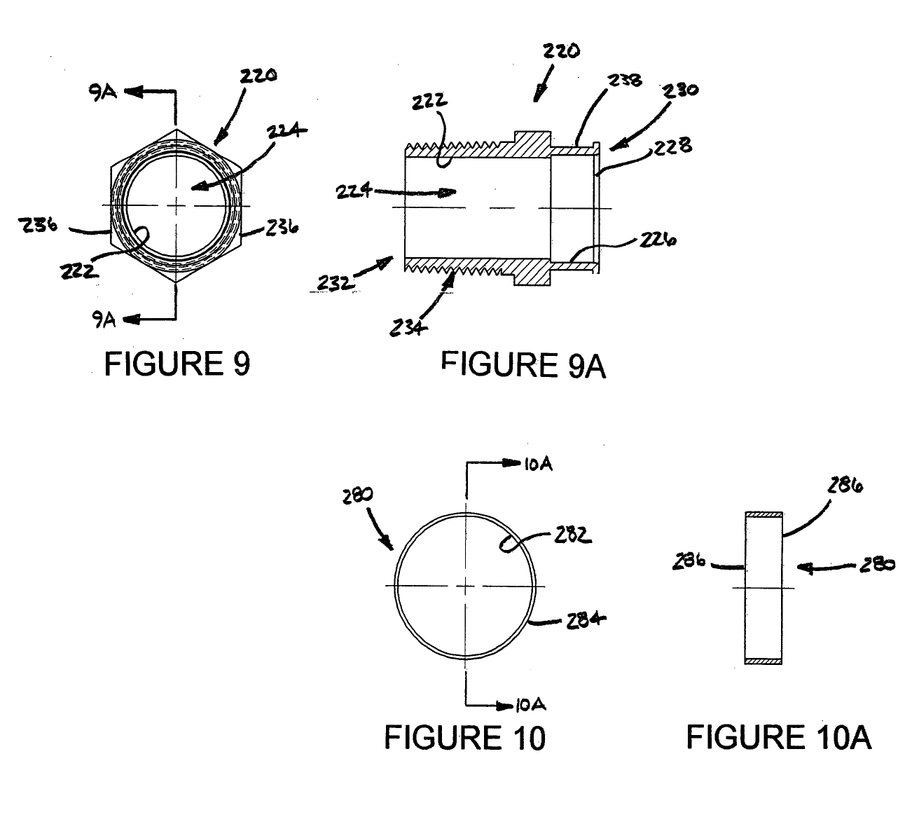

FIGS. 9 and 9A illustrate first end fitting 220, which includes an inside wall 222 defining a passage 224 extending therethrough. The inside wall includes a brazing surface 226 and a chamfer 228 adjacent a tube-engaging end 230. A connecting end 232 extends opposite the tube-engaging end. A plurality of threads 234 are disposed along the exterior of fitting 220 toward the connecting end, and wrench flats 236 are provided adjacent the threads. A retaining groove 238 extends about the exterior of end fitting 220 adjacent tube-engaging end 230. The retaining groove is suitable for receiving at least a portion of sheath 260. A retaining collar 280 is shown in FIGS. 10 and 10A and includes an inside surface 282, an outside surface 284 and two opposing ends 286. The retaining collar is positioned adjacent retaining groove 238 of end fitting 220 and is crimped or otherwise radially inwardly deformed to compressively secure sheath 260 against groove 238 of end fitting 220.

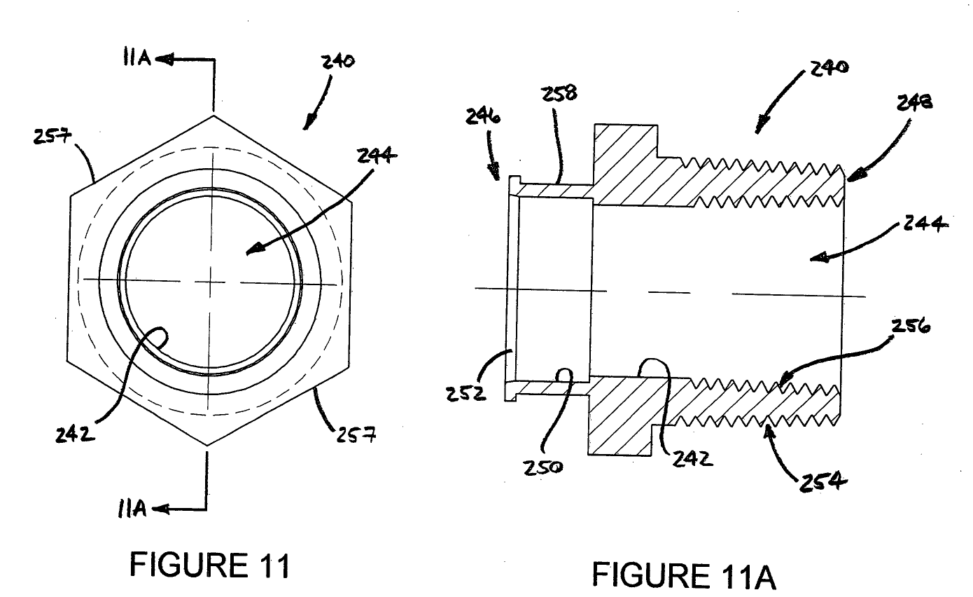

FIGS. 11 and 11A show second end fitting 240 having an inside wall 242 defining a passage 244. The second end fitting has a tube-engaging end 246 and a connecting end 248. Adjacent the tube-engaging end, a brazing surface 250 is disposed along inside wall 242, and a chamfer 252 is provided at the edge thereof. Adjacent connector end 248 is a plurality of male threads 254 extending along the exterior of the end fitting. A plurality of female threads 256 extends along inside wall 242 from connecting end 248. Wrench flats 257 also extend along the exterior of the end fitting. A retaining groove 258 is disposed along the exterior of end fitting 240. As discussed with regard to FIGS. 9, 9A, 10 and 10A, the retaining groove is suitable for receiving at least a portion of sheath 260 and receives a retaining collar 280 in a manner substantially identical to that discussed with regard to first end fitting 220.

End fittings 220, 240 illustrated in at least FIGS. 7, 9, 9A, 11 and 11A are shown as having tapered pipe threads thereon. It will be appreciated, however, that any suitable threads, such as straight threads, for example, or other connection structures, such as a flange, for example, can be used without departing from the principles of the present invention. Indeed, the present invention is intended to include the use of end fittings of any geometry or configuration that is suitable for any desired application of a connector assembly in accordance with the present invention. The subject invention is not intended to be limited to the geometry shown in the aforementioned drawing figures, as a nearly unlimited number of end fitting configurations exist that would be suitable for use with the invention in the present application.

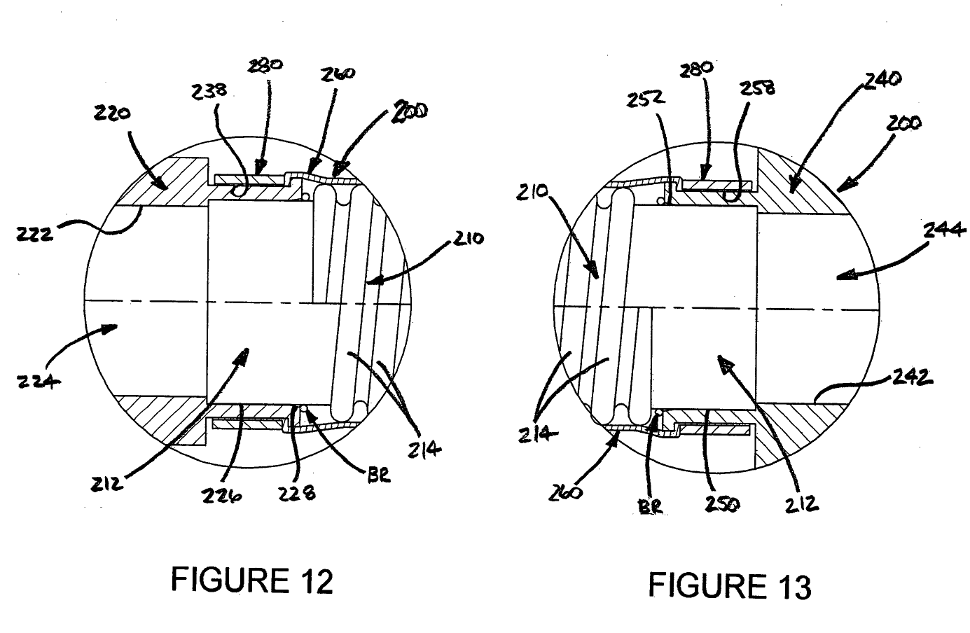

End fittings 220 and 240 are each retained on a different one of end portions 212 of flexible tubing 210 by a brazed joint or connection. And, it is to be specifically understood that such a brazed connection does not include welding, welded joints, or other welded connections or arrangements. FIGS. 12 and 13 respectively illustrate fittings 220 and 240 supported on the end portions of the flexible tubing. A braze ring BR is positioned adjacent chamfers 228 and 252, as respectively shown in FIGS. 12 and 13.

Another and/or alternate method of assembling a connector assembly in accordance with the present invention, such as connector assembly 200, includes the steps of: providing a length of flexible tubing 210, such as thin-walled, corrugated tubing, for example, having two opposing, non-corrugated and generally cylindrical end portions 212; providing an end fitting 220, 240 suitably adapted to receivingly engage each of the two end portions; assembling each of the provided end fittings onto an associated end portion; brazing each end fitting onto the associated end portion using a brazing material suitable for withstanding relatively high temperatures, such as temperatures above 300° F., for example; providing a sheath 260 and assembling the sheath along the exterior of tubing 210 and along at least a portion of each of the two end fittings; providing two retaining collars 280, and assembling a collar over the sheath and adjacent each of the end fittings; and crimping or otherwise radially inwardly deforming the retaining collars onto the associated end fitting to compressively secure the sheath therebetween. It will be appreciated that under some circumstances the retaining collar may not fit over one or more of the end fittings. In such situations, it can be desirable to install the retaining collar prior to assembly of the end fitting onto the flexible tubing. It will also be appreciated that the retaining collars can be split collars, in this or other embodiments.

The brazing material can take any one of various forms, such as a rod, a length of wire, or braze ring BR, for example. It will be appreciated that braze ring BR can be a continuous ring, or a discontinuous or split ring. As a continuous ring, it is desirable to assemble braze ring BR onto the at least one end portion prior to assembly of the end fitting. However, in other forms the brazing material may be provided at any one of various points during the assembly process, such as prior to assembly of the end fitting onto the end portion or during the braze operation itself, for example.

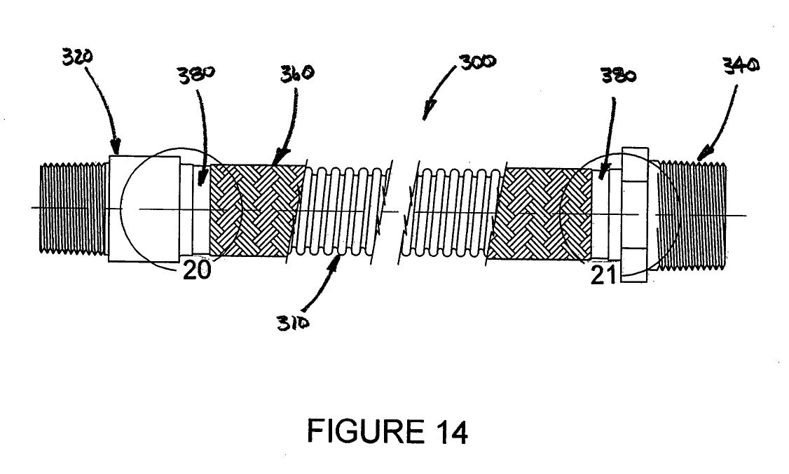

FIG. 14 illustrates still another and/or alternate embodiment of a fluid line connector assembly 300 that includes a length of thin-walled, flexible tubing 310, a first end fitting 320, a second end fitting 340, a sheath 360, one or more base rings 370 (not shown in FIG. 14), and one or more retaining collars 380.

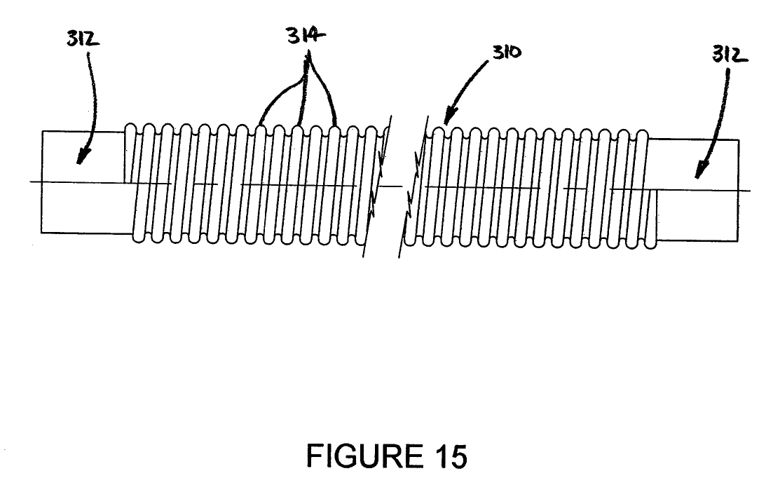

FIGS. 15-19 illustrate various components of connector assembly 300. FIG. 15 shows a length of flexible tubing 310 having cylindrical end portions 312 and a plurality of corrugations 314 extending between the non-corrugated end portions. Typically, tubing 310 is formed from stainless steel. However, it will be appreciated that other suitable materials, such as carbon steel, for example, may be used without departing from the principles of the present invention. The tubing can have a wall thickness of about approximately 0.005 to about approximately 0.035 inches. Commonly, the tubing has a wall thickness of about approximately 0.010 to about approximately 0.015 inches. This falls within the aforementioned broader range, and is not intended as a limitation but merely as an illustration of suitable thickness dimensions. Additionally, corrugations 314 are shown as being helical corrugations. However, it should be appreciated that any other suitable manner of forming flexible tubing may be used, such as using annular corrugations, for example.

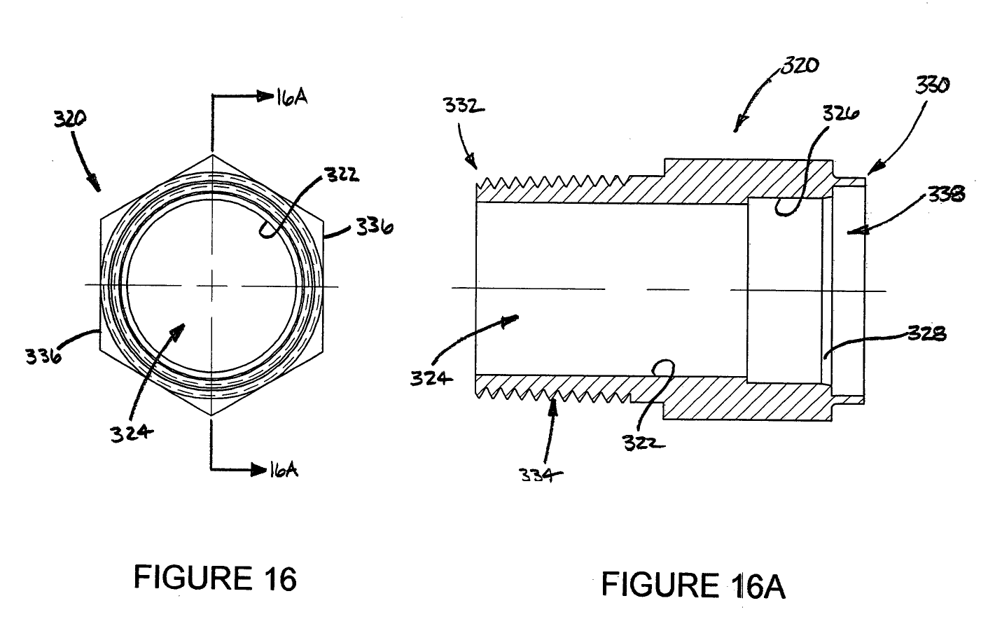

FIGS. 16 and 16A illustrate first end fitting 320 which includes an inside wall 322 defining a passage 324 extending therethrough. The inside wall includes a brazing surface 326 and a chamfer 328 adjacent a tube-engaging end 330. A connecting end 332 extends opposite the tube-engaging end. A plurality of threads 334 are disposed along the exterior of fitting 320 toward the connecting end, and wrench flats 336 are provided adjacent the threads. A cuff 338 extends axially outwardly from the end fitting at tube-engaging end 330.

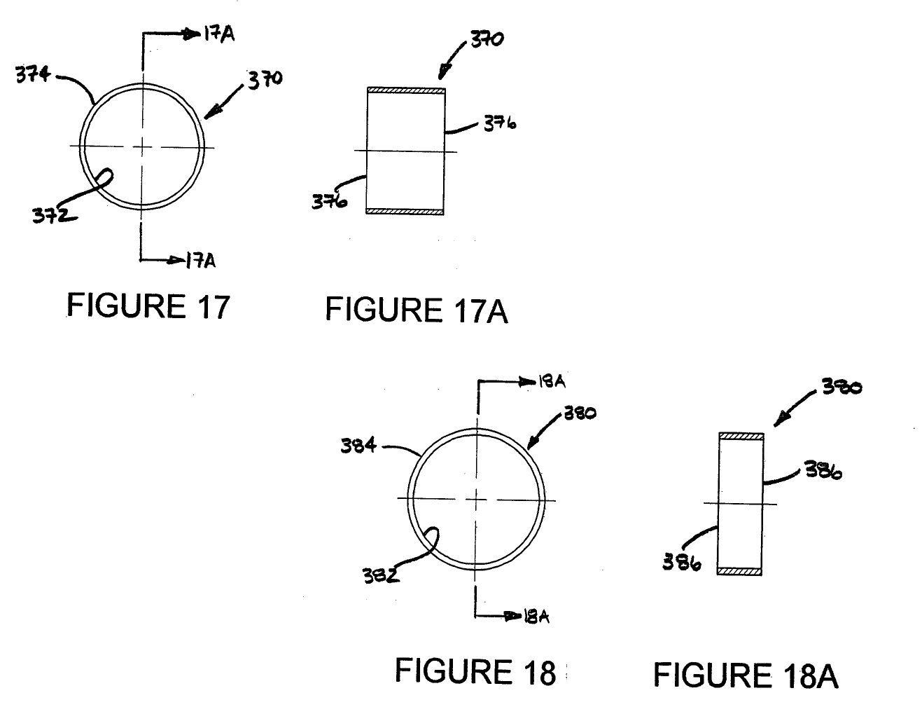

FIGS. 17, 17A, 18 and 18A respectively illustrate base collar 370 and retaining collar 380. The base collar shown in FIGS. 17 and 17A includes an inside wall 372, an outside wall 374, and opposing ends 376. The retaining collar shown in FIGS. 18 and 18A similarly includes an inside wall 382, an outside wall 384, and two opposing ends 386. It will be appreciated that the base collar shown in FIGS. 17 and 17A will have an inside diameter suitable for receivingly engaging tubing end 312 of flexible tubing 310. The retaining collar shown in FIGS. 18 and 18A will have an inside diameter greater than the outside diameter of the base collar and suitable for permitting a portion of sheath 360 to extend between outside wall 374 and inside wall 382.

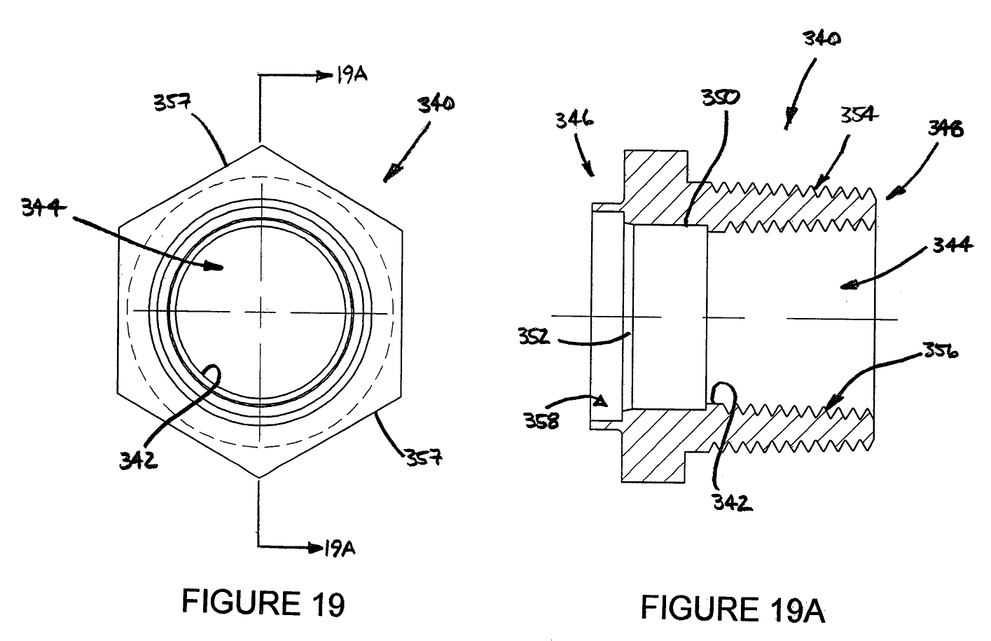

FIGS. 19 and 19A show second end fitting 340 having an inside wall 342 defining a passage 344. The second end fitting has a tube-engaging end 346 and a connecting end 348. Adjacent the tube-engaging end, a brazing surface 350 is disposed along inside wall 342, and a chamfer 352 is provided at the edge thereof. Adjacent connector end 348 is a plurality of male threads 354 extending along the exterior of the end fitting. A plurality of female threads 356 extends along inside wall 342 from connecting end 348. Wrench flats 357 also extend along the exterior of the end fitting. A cuff 358 extends axially outwardly from end fitting 340 at tube-engaging end 346.

End fittings 320, 340 illustrated in at least FIGS. 14, 16, 16A, 19 and 19A are shown as having tapered pipe threads thereon. It will be appreciated, however, that any suitable threads, such as straight threads, for example, or other connection structures, such as a flange, for example, can be used without departing from the principles of the present invention. Indeed, the present invention is intended to include the use of end fittings of any geometry or configuration that is suitable for any desired application of a connector assembly in accordance with the present invention. The subject invention is not intended to be limited to the geometry shown in the aforementioned drawing figures, as a nearly unlimited number of end fitting configurations exist that would be suitable for use with the invention in the present application.

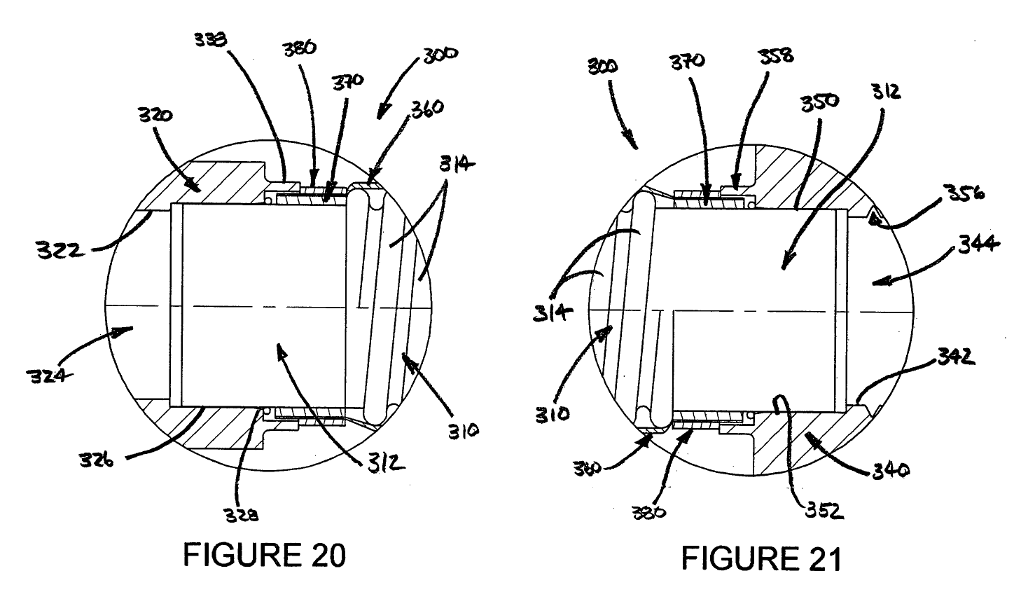

End fittings 320 and 340 are each retained on a different one of tubing ends 312 by a brazed joint or connection. It is to be specifically understood that such brazed connections do not include welding, welded joints, or any other welded connections or arrangements. FIGS. 20 and 21 respectively illustrate fittings 320 and 340 supported on an end portion 312 of the flexible tubing. A base collar 370 is positioned along each of end portions 312 axially inwardly of the associated end fitting. A portion of sheath 360 extends along the outside wall of the base collar and a retaining collar 380 is positioned radially outwardly of sheath 360 and shown crimped or otherwise radially inwardly deformed to compressively retain sheath 360 adjacent each tubing end portion. A braze ring BR is positioned adjacent chamfers 328 and 352 as respectively shown in FIGS. 20 and 21.

Still another and/or alternate method of assembling a connector assembly in accordance with the present invention, such as connector assembly 300, includes the steps of: providing a length of flexible tubing 310, such as thin-walled, corrugated tubing, for example, having two opposing, non-corrugated and generally cylindrical end portions 312; providing two base rings 370 and assembling each of the base rings onto a different one of the opposing end portions; providing a sheath 360, and assembling the sheath along the exterior of tubing 310 and extending at least a portion of the sheath along at least a portion of each of the base rings; providing two retaining collars 380, and assembling a collar over the sheath and adjacent each of the base rings; crimping or otherwise radially inwardly deforming the retaining collars onto the associated base ring to compressively secure the sheath therebetween; providing an end fitting 320, 340 suitably adapted to receivingly engage one or more of the two opposing end portions; assembling each of the provided end fittings onto an associated one of the two end portions; and brazing each end fitting onto the associated end portion using a brazing material suitable for withstanding relatively high temperatures, such as temperatures above 300° F., for example.

The brazing material can take any one of various forms, such as a rod, a length of wire, or braze ring BR, for example. It will be appreciated that braze ring BR can be a continuous ring, or a discontinuous or split ring. As a continuous ring, it is desirable to assemble braze ring BR onto the at least one end portion prior to assembly of the end fitting. However, in other forms the brazing material may be provided at any one of various points during the assembly process, such as prior to assembly of the end fitting onto the end portion or during the braze operation itself, for example.

In each of the embodiments discussed above, it is desirable for the brazed joint to maintain its integrity at elevated ambient temperatures, such as above 300° F., for example. Accordingly, the brazing material used should have a liquid temperature sufficiently high, such as a temperature above 500 degrees Fahrenheit, for example, such that the brazed joint will maintain its integrity at such elevated ambient temperatures. Braze ring BR discussed above should be formed from such a brazing material. It will be appreciated that braze ring BR can be either a continuous ring, or be a discontinuous or split ring of braze material, such as brazing wire, for example. Furthermore, depending on the details of the brazing process in use, the braze material may be introduced to the brazing site in a form other than a ring, such as a wire, for example.

The braze material can include from about 30 percent to about 70 percent silver, and from about 1 percent to about 40 percent copper. Another and/or alternate braze material can include from about 30 percent to about 70 percent silver, and from about 10 percent to about 50 percent zinc. Still another and/or alternate braze material can include from about 40 percent to about 60 percent silver, from about 10 to about 30 percent copper, and from about 20 to about 40 percent zinc. A further and/or alternate braze material can include from about 45 to about 55 percent silver, from about 15 to about 25 percent copper, from about 23 to about 33 percent zinc, and from about 0.5 to about 4 percent nickel. One suitable material, for example, is Braze 505 with a flux core, which is manufactured by Lucas-Milhaupt. Braze 505 has a liquidus temperature in excess of 1300° F.

Brazing and brazing processes, such as furnace brazing, induction brazing, resistance brazing and torch brazing, for example, are well known to those of skill in the art. Additionally, background information regarding brazing, brazing materials and brazing processes can be found various publications, including Brazing For the Engineering Technologist by M. Schwartz, 1^{st} ed., 1995, the disclosure of which at pages 1-332 has been incorporated herein by reference.

A sheath is discussed above as item numbers 260 and 360. It will be appreciated that any suitable material or construction of a sheath can be used. One example of a suitable sheath is braided from metal wires, such as stainless steel wires, that are braided together in groups. The braided sheath can include from about 10 to about 50 groups, with from about 2 to about 20 wires per group. Typically, the wire is from about 0.005 to about 0.025 inches in diameter. It will be appreciated that such braided sheaths and methods of manufacturing braided sheaths are generally well known to those of skill in the art. As such, further discussion thereof is not provided. It will be further appreciated, however, that any suitable sheath material or construction can be used.

As mentioned above, it is desirable to manufacture the subject end fittings, as well as other parts, from a material other than stainless steel, such as carbon steel, for example, to reduce cost. However, since carbon steel has a tendency to oxidize, it is beneficial to coat these parts to improve corrosion resistance and appearance, as well as for other reasons. One such suitable coating process, for example, is electroless nickel plating. This coating process is suitable for the subject component parts and the resulting surface finish has been found to provide many useful qualities and characteristics. However, it will be appreciated that other suitable coatings or surface finishes exist, and the use of any of these other processes, coatings or finishes is intended to be included within the scope of the present invention.

Both the electroless nickel plating process and resulting surface finish, as well as many other details of electroless nickel plating, are a well known to those of skill in the art. Additionally, many variations of electroless nickel plating exist, and some may be more suitable than others for the present application. Additional background information regarding electroless nickel plating, the resulting surface finish, as well as many other characteristics of the process can be found in various publications, including Electroless Nickel Plating by Wolfgang Riedel, 1^{st} ed, 1991, the disclosure of which at pages 1-7, 64-159 and 178-220 has been incorporated herein by reference.

It has been found that coating the subject component parts in a manner conforming with certain standards, such as MIL-C-26074E Class 1, Grade B; or SAE-AMS 2404C, for example, provides a suitable coating or surface finish for the present application. However, it will be appreciated that variations of these standards, such as later revisions, or even entirely different standards may also be suitable for the present application, and the subject invention is intended to encompass all suitable coatings conforming to any such other standards.

It is to be understood that welding and brazing are not considered to be equivalent methods of joining the components of a fluid line connector assembly in accordance with the present invention, and this disclosure specifically differentiates the present invention from welded constructions. Welding, which specifically includes localized melting of the two base materials being joined by the filler metal, has numerous disadvantages that have been avoided or overcome by the brazed construction of the present invention. Brazing does not permit melting of the base materials, but rather requires the filler metal to flow between the surfaces of the base materials to be joined. The benefits of the brazed construction include improved corrosion resistance, reduced cost, better cosmetic appearance, and the ability to disassemble or rework assemblies in a non-destructive manner. Due to the nature of the specific disadvantages of welding in view of brazing, welding is considered to be non-analogous to brazing for the purposes of this disclosure.

While the invention has been described with reference to the foregoing embodiments and considerable emphasis has been placed herein on the structures and structural interrelationships between the component parts of the embodiments disclosed, it will be appreciated that other embodiments of the invention can be made and that many changes can be made in the embodiments illustrated and described without departing from the principles of the invention. Obviously, modifications and alterations will occur to others upon reading and understanding the preceding detailed description. Accordingly, it is to be distinctly understood that the foregoing descriptive matter is to be interpreted merely as illustrative of the present invention and not as a limitation. As such, it is intended that the invention be construed as including all such modifications and alterations insofar as they come within the scope of this disclosure.

What is claimed is:

1. A fluid line connector assembly comprising:
a length of flexible tubing having a generally cylindrical tubing end; and,
an end fitting secured on said tubing end using a brazing material.

2. A fluid line connector assembly according to claim 1, wherein said flexible tubing is corrugated tubing and said cylindrical tubing end includes a non-corrugated portion.

3. A fluid line connector assembly according to claim 2, wherein said corrugations are helical corrugations.

4. A fluid line connector assembly according to claim 1, wherein said end fitting has an inside wall and an outside wall, and said inside wall forms a passage through said end fitting.

5. A fluid line connector assembly according to claim 4, wherein at least a portion of said inside wall is spaced radially outwardly from said tubing end and said brazing material is disposed within said space therebetween.

6. A fluid line connector assembly according to claim 5, wherein each of said tubing end and said passage has an axis, and said end fitting is positioned on said tubing end such that said passage is coaxially received on said tubing end.

7. A fluid line connector assembly according to claim 1, wherein said end fitting is formed from a material that readily oxidizes.

8. A fluid line connector assembly according to claim 7, wherein said material is low-carbon steel.

9. A fluid line connector assembly according to claim 1, wherein said end fitting is plated.

10. A fluid line connector assembly according to claim 9, wherein said plating is an electroless nickel plating.

11. A fluid line connector assembly according to claim 1, wherein said brazing material has a liquidus temperature above about 300 degrees Fahrenheit.

12. A fluid line connector assembly according to claim 11, wherein said brazing material is comprised of from about thirty (30) percent to about seventy (70) percent silver.

13. A fluid line connector assembly according to claim 12, wherein said brazing material is further comprised of from about one (1) percent to about forty (40) percent copper.

14. A fluid line connector assembly according to claim 12, wherein said brazing material is further comprised of from about ten (10) percent to about fifty (50) percent zinc.

15. A fluid line connector assembly according to claim 12, wherein said brazing material is further comprised of from about one-half (0.5) percent to about four (4) percent nickel.

16. A fluid line connector assembly according to claim 1 further comprising a base collar on said tubing end, a sheath extending along at least a portion of said flexible tubing and said base collar, and a retaining collar retaining said sheath in abutting engagement with said base collar.

17. A fluid line connector assembly according to claim 16, wherein said end fitting includes an axially outwardly extending annular cuff.

18. A fluid line connector assembly according to claim 16, wherein said base collar is integrally formed as a portion of said end fitting.

19. A fluid line connector assembly according to claim 18, wherein said base collar portion of said end fitting includes a radially outwardly extending wall, and at least a portion of said retaining ring extends radially inwardly of said outwardly extending wall.

20. A fluid line connector assembly according to claim 1, wherein said end fitting includes a plurality of threads extending along at least a portion thereof.

21. A fluid line connector assembly comprising:
a length of flexible tubing having a generally cylindrical tubing end;
an end fitting secured on said tubing end using a brazing material;
a base collar on said tubing end;
a retaining collar in radially outwardly spaced relation to said base collar; and,
a sheath extending along a portion of flexible tubing and said base collar, and compressively retained in abutting engagement with said base collar by said retaining collar.

22. A fluid line connector assembly according to claim 21, wherein said end fitting has an inside wall and an outside wall, and said inside wall forms a passage through said end fitting.

23. A fluid line connector assembly according to claim 22, wherein at least a portion of said inside wall is spaced radially outwardly from said tubing end and said brazing material is disposed within said space therebetween.

24. A fluid line connector assembly according to claim 21, wherein said end fitting is plated.

25. A fluid line connector assembly according to claim 21, wherein said end fitting includes an axially outwardly extending annular cuff.

26. A fluid line connector assembly according to claim 21, wherein said base collar is integrally formed as a portion of said end fitting.

27. A fluid line connector assembly according to claim 21, wherein said brazing material has a liquidus temperature above about 300 degrees Fahrenheit.

28. A fluid line connector assembly according to claim 27, wherein said brazing material is comprised of from about thirty (30) percent to about seventy (70) percent silver.

29. A fluid line connector assembly according to claim 28, wherein said brazing material is further comprised of from about one (1) percent to about forty (40) percent copper.

30. Fluid line connector assembly according to claim 29, wherein said brazing material is further comprised of from about ten (10) percent to about fifty (50) percent zinc.

31. A fluid line connector assembly according to claim 30, wherein said brazing material is further comprised of from about one half (0.5) percent to about four (4) percent nickel.

32. A fluid line connector assembly according to claim 31, wherein said end fitting is plated.

33. A fluid line connector assembly according to claim 32, wherein said plating is electroless nickel plating.

34. A method of assembling a fluid line connector assembly comprising the steps of:
A. providing a length of flexible tubing having a generally cylindrical tubing end and an end fitting having an inside wall forming a passage through said end fitting;
B. installing said end fitting on said tubing end such that at least a portion of said inside wall is spaced radially outwardly from said tubing end;
C. heating at least one of said tubing end and said end fitting; and,
D. introducing a quantity of brazing material into said space between said inside wall and said tubing end forming a brazed connection therebetween.

35. A fluid line connector assembly according to claim 34, wherein said brazing material has a liquidus temperature above about 300 degrees Fahrenheit.

36. A fluid line connector assembly according to claim 35, wherein said brazing material is comprised of from about thirty (30) percent to about seventy (70) percent silver.

37. A method according to claim 34 further comprising a step of providing a sheath and extending said sheath along said flexible tubing prior to step B.

38. A fluid line connector assembly according to claim 37 further comprising a step of providing a base collar and a retaining collar; positioning said base collar on said tubing end; extending said sheath along a portion of said tubing end; and radially inwardly deforming said retaining collar to secure said sheath in abutting engagement with said base collar prior to step B.

39. A fluid line connector assembly according to claim 37 further comprising the steps of providing a retaining ring and positioning said retaining ring on said flexible tubing prior to step B.

40. A fluid line connector assembly according to claim 39, wherein said end fitting includes a base ring integrally formed thereon.

41. A fluid line connector assembly according to claim 40 further comprising steps of extending said sheath along said base ring integrally formed on said end fitting and radially inwardly said retaining collar to secure said sheath in a butting arrangement with said base collar after step B.
